(19) United States
(12) Patent Application Publication
(10) Pub. No.: US 2006/0047809 A1
(43) Pub. Date: Mar. 2, 2006

(54) Method and apparatus for assessing performance and health of an information processing network

(76) Inventors: Terrance C. Slattery, Annapolis, MD (US); Frank M. Pittelli, Edgewater, MD (US)

Correspondence Address: FOLEY AND LARDNER LLP;SUITE 500, 3000 K STREET NW, WASHINGTON, DC, 20007, US

(21) Appl. No.: 10/931,222

(22) Filed: Sep. 1, 2004

(51) Int. Cl. G06F 15/173

(52) U.S. Cl. 709/224

(57) ABSTRACT

Network functional components made up of a set of network elements (routers, switches and other infrastructure devices) communicating and cooperating to implement a network service such as a routing protocol or the spanning tree used to implement VLANs, are assigned performance and/or health metrics, which are communicated through a communications device, such as a display or speaker. A “Correct” performance metric for each network functional component of the network indicates that functional network component's conformance to a set of programmed configuration standards, which typically represent best practices for the network. A “Stable” performance metric for each network functional component indicates the degree to which that network functional component is operating efficiently and effectively. By combining these performance metrics for the individual network functional components, for instance by averaging them, one can arrive at a single performance metric for the entire network. The metric scales are is arbitrary, for example a scale of 0-10 can be used, and can accommodate weighting of the values based on the seriousness of performance issues identified on the network.

### FIELD OF THE INVENTION

The invention relates to information processing networks, generally. In particular, the invention concerns a method and apparatus for monitoring and assessing the health of a network.

### BACKGROUND

By most standards, networking is a relatively new technology. Network management is hampered by clumsy mechanisms, such as network maps and event and element viewers that provide limited insight into network health. However, network management has become more and more important as information processing networks have grown in size and complexity and as modem computing and information systems have come to depend on more extensively on complex networks structures. Network management technology has focused on device and interface monitoring, as well as event log filtering systems that identify significant events and provide alerts to network staff. Such systems include HP Open View, What's Up Gold and Circket/MRTG. Each of these systems differs from the others in cost, complexity and results produced. For example, HP Open View is aimed at larger networks, requires significant training and configuration and is costly, but performs multiple functions. What's UP Gold is simpler and less expensive. Providing basic interface performance, log file monitoring, alerting, and device availability. Cricket.MRTG is a free network performance package typically used to display interface utilization data and error data.

Systems such as those discussed above are limited because they are aimed at identifying specific events. They do not provide a single measure of performance that allows one to assess health of a network. These systems also do not provide a network administrator the ability to spot trends that may indicate a problem in the making before it becomes a critical matter.

Network management systems that have attempted to assess network health have used traditional measures of network health, such as availability, performance, or an average of the health of individual network elements (routers, switches, and other network infrastructure devices).

Network availability as a measure of network health may be typically measured by monitoring the availability of each network element and then calculating the overall network availability, possibility taking into account the relative importance of each element. Several methods of determining individual network element availability may be used. One method known in the art records whether each element responds to frequent ping requests. A ping request causes the element to respond that it is operational. Those of ordinary skill in computer and networking systems will understand how to construct and implement network or application level pinging. If the element does not respond to the ping, the element is assumed to be unavailable for the some part of the time period between the last successful ping and the failed ping.

A variety of methods may be used to calculate the availability metric once the element availability has been measured. Scheduled maintenance outages for specific elements are typically excluded from the overall availability metric. One calculation method discards the data for elements for which a scheduled maintenance outage existed. The total time that all elements were available is divided by the total time that all elements should have been available. The result is a ratio that is very close to 1.000 for highly reliable networks. Another calculation method could take into account the importance of the network elements and assign a greater weight to outages of important elements. Another calculation could take into account redundancy in the network and whether the outage of a specific element affects delivered network services.

Network performance as a measure of network health typically checks the performance and utilization of CPU, memory, and interfaces of network elements (routers and switches). The Concord E-Health product uses network performance statistics to create a network health report. It focuses on the performance of network elements (routers and switches) and summarizes the resulting performance into an overall network health report. A single score is not provided.

An Open Source Software system, NMIS (Network Management Information System), uses element-based metrics to arrive at an overall network score. The metrics are an element's Health (measured by CPU, Memory, Buffers, and Interface Utilization), Availability, Reachability, and Response Time. The values of these metrics are averaged for all elements to yield an overall metric for the network. The overall network score is the average of the different metrics. The NMIS dashboard is seen in the figure below, showing the overall network score, based on the Health, Availability, and Reachability metrics.

These systems are limited, however, because they focus on the performance of individual devices in a system and do not address the performance of functional network components or subsystems and do not correlate individual device performance to the performance of such functional network components or subsystems.

### SUMMARY AND OBJECTS OF THE INVENTION

In view of the above, it is an object of the invention to provide a method an apparatus that provides a single measure or score of network performance. It is also an object of the invention to provide such a score for functional components of a network.

In contrast to conventional systems, a method and apparatus according to the invention uses scores of network subsystems based on the “correctness”, which addresses the configuration of the network according to industry best practices, and “stability” of the subsystem, which address the question of whether the subsystem is stable and operating at acceptable utilization levels.

According to the invention, one can represent an operating condition of an information processing network by detecting the presence of information processing devices on the information processing network and gathering data concerning performance parameters of the devices on said network in order to develop performance metrics. The data is correlated to arrive at correlations between the data and performance of network functional components. The data and correlations are synthesized into a single score indicating the conformance of at least one of the functional network components to a programmed set of network practices. Another score can be developed that indicates the stability of the network, as indicated by its efficiency and effectiveness. These functional network component performance metrics, can then be combined, for example, by averaging them, to arrive at a single performance metric for the network. The scale can be arbitrary and can employ weighting techniques to account for severity of impact on network performance.

### BRIEF DESCRIPTION OF THE DRAWINGS

The invention is described herein with reference to the drawings in which:

FIG. 1 illustrates an open source network management information system “dashboard”.

FIG. 2 illustrates a network scorecard according to the invention.

FIG. 3 illustrates an issue summary report produced using a method an apparatus according to the invention.

FIG. 4 illustrates an issue list produced using a method an apparatus according to the invention.

FIG. 5 illustrates a device summary report produced using a method an apparatus according to the invention.

FIG. 6 illustrates a subnet summary report produced using a method an apparatus according to the invention.

FIG. 7 illustrates a route summary display produced using a method an apparatus according to the invention.

FIG. 8 illustrates a VLAN summary chart produced using a method and apparatus according to the invention.

FIG. 9 illustrates a Chart showing HSRPs discovered in a network using a method and apparatus according to the invention.

FIG. 10 illustrates a chart showing the number of configuration changes made across Cisco devices for which configuration files have been gathered using a method and apparatus according to the invention.

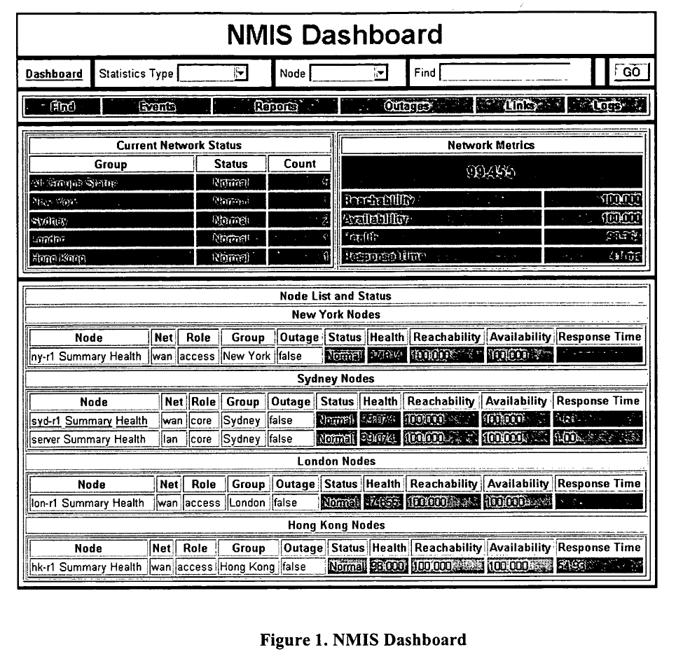

### DESCRIPTION OF THE EMBODIMENTS

An information processing network can contain hundreds of information processing elements such as computers, routers, switches and other information processing devices. As network elements are added and a network grows in complexity, the network must be properly managed to avoid bottlenecks, inefficiencies and failures. Moreover, the addition of an element may have an unintended effect on other elements of the network or on the network performance as a whole.

Components of a successful network management system include features that address event alerting and device management, such as event correlation and root cause analysis, configuration storage information, bandwidth consumer and bill back systems information, trend analysis and intrusion detection and authorization and related security matters. Useful information to a network administrator focuses on more than the performance of the network elements. Providing such information requires network diagnosis reporting and troubleshooting tools, configuration and operating system auditing, checker and builder tools, information about who and what is generating network loads, historical data for trending and fault prediction, determining correct subsystem configuration, as well as security hole and intrusion detection.

A method or apparatus according to the invention provides a network administrator information in a manner and form that allows a quick assessment of the overall health of the network. This information is in the form of “correct” and “stable” performance metrics for functional network components and a composite metric indicative of the overall health of the network. Tracking metrics provided by a method or apparatus according to the invention over time advantageously also provides a representation of a network's performance trends.

A method and/or apparatus according to the invention provides for monitoring the overall performance of an information processing network. A modem network includes a large number of functional network components and interacting systems. Thus, taking the number of routers and switches and creating a metric showing the percentage not having major problems, while convenient, fails to account for network wide systems such as routing protocol stability or VLAN stability. In addition, a metric that represents a mechanical assessment of parameters of individual elements without correlation to the network, also fails to provide a good measure of network performance.

According to the invention, which may be implemented in a hardware and/or software in a network node or as a stand-alone appliance that can be connected to a network, data is gathered from multiple sources to gain an understanding of the network and its topology, layout and architecture. Performance parameters of the individual elements and network parameters are gathered and accumulated over time. The performance data and relevant correlations allow inferences to be drawn as to the overall health of the network at any given point in time. This information also allows detection of developing issues. In this way, a method and apparatus according to the invention allows a network administrator to act to correct issues that have been identified before they become critical network bottlenecks or failures. By applying expert rules and industry best practices criteria, the overall health of the network can be assessed. Indeed, one feature of the invention is the generation of a single quantitative or qualitative network health measure or network score for the network. Such a measure or score, which according to the invention can be any arbitrarily selected scale that conveys the overall health status of the network, provides network administrators an immediate assessment of the overall health of a network.

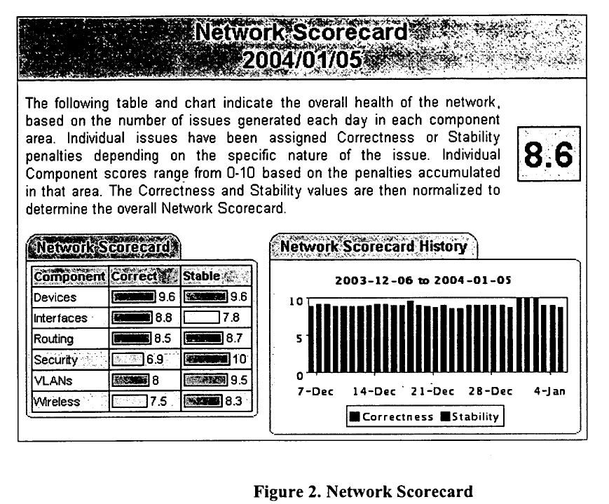

A method or apparatus according to the invention analyzes network data and produces a metric or score for each of any number of functional network components or subsystems, as shown in FIG. 2. A subsystem or functional network component includes a set of network elements (routers, switches and other infrastructure devices) communicating and cooperating to implement a network service such as a routing protocol or the spanning tree used to implement VLANs. This analysis of functional network components or subsystems, rather than individual devices, correlates the results of measurements made on individual device and is one distinguishing feature of the invention. Other network management systems that produce a single score value focus only on devices, not the functional network components or subsystems that must be properly configured and operating for the network to run correctly and efficiently.

One approach to assessing a network according to the invention is demonstrated in the network scorecard shown in FIG. 2. As shown in FIG. 2, performance data of the network is synthesized into network functional component categories, such as devices, interfaces, routing, security, VLANs and wireless. Other categories can be provided as needed, without departing from the method and apparatus according to the invention. It is desirable to intelligently select the functioning component categories for a particular network. The categories can be selected to provide network administrators an easy way to identify the portions of a particular network that require remediation and to set priorities. For each network component a Correct Score and a Stable Score is assigned as to whether the network component is operating correctly and is stable.

The analysis of each subsystem measures both “correctness”, i.e. whether the subsystem is configured and operating correctly, via the Correct metric and “stability”, i.e., whether the subsystem is stable and is operating with acceptable performance limits, via the Stable metric. For example, a VLAN will typically be comprised of multiple switches that communicate with each other using the Spanning Tree Protocol (e.g., 802.11d), perhaps in conjunction with a VLAN trunking protocol (e.g., 802.11q). The set of all switches in the VLAN must be configured correctly and operating efficiently and must be stable for the VLAN to offer acceptable performance as a network subsystem.

The Correct metric addresses whether the Component (e.g., the VLAN as described above) is configured and operating correctly. For example, industry best practices (defined by internetworking experts and industry vendors) recommend that a root bridge and a standby root bridge be selected for each VLAN. Therefore, as part of its Correct metric for VLANS, an apparatus or method according to the invention checks that a root and standby root bridge have been specified. A similar check is performed to make sure that the redundancy offered by Hot Standby Routing Protocol (HSRP) groups has not been compromised.

The Stable metric addresses whether the functional network component is stable and operating efficiently and effectively. For example, for VLANs a method or apparatus according to the invention checks that the root bridge for each VLAN is stable and has not changed during a specified time period, such as one day. Other analysis rules check for efficient operation and that the switch ports in the VLAN are not operating with duplex mismatch in which the switch and client have selected different duplex modes.

Those of ordinary skill in the art will recognize that other metrics could be created in addition to Correct and Stable and that additional functional network components, such as Voice over IP, are likely to be identified as network technology advances, without departing from the scope of the invention.

In the example shown in FIG. 2, the scores of the functional network components are based on a scale of 0 to 10, with 10 being a perfect score. As shown in FIG. 2, the network itself is also assigned and composite performance score, which represents the overall health of the network. Those of ordinary skill will recognize that the selection of the scales is arbitrary and that any other scale could be employed effectively. For example, a scale of 0-100, with 100 being a perfect score, could be used. In addition, it is not required that the overall composite network score by scaled in the same manner as the scale used for the network components.

In the example in FIG. 2, the assumption is that each network functional component category starts with a perfect score, i.e., 10. The number of exceptions and issues detected in the network's operation over a period of time in each area is then evaluated and penalty points assessed. Individual issues and exceptions may be weighted according to the seriousness of their impact on network performance to arrive at the penalty point values. The penalty points are then subtracted from the perfect 10 score starting point for each component.

For example, according to the invention issues can classified into Error, Warning, or Informational severity levels. Initially assuming that the network is perfect (score=10), the score is decreased for each issue that is identified. Error issues carry a larger penalty than Warnings, which in turn carry a larger penalty than Information issues. The rules can be implemented as either simple fixed rules or as an expert system or as a dynamic, self-learning rule base.

The score of each functional network component or subsystem is calculated independently of that of the other functional network components or subsytems. The score is normalized, based on the total number of issues possible for the network component so that as additional issues are added, the scoring adjusts to the total number of issues. Other scoring mechanisms may be used as would be known to someone skilled in the art. One example is to add the scores of all issues to achieve an overall figure that is proportional to the number and severity of all identified issues. As the number and severity of the issues increases, the higher the score.

The overall single network performance score determined by an exemplary method or apparatus according to the invention is calculated by averaging the scores of all functional network components (Components in FIG. 2) in both Correct and Stable categories. In the Network Scorecard of FIG. 2, the average sums all the Component scores for both Correct and Stable categories, then divides by 12, which is the number of individual scores. As with the Component scores, other summary scoring mechanisms may be used. One example would be to sum the Component scores as described above. Those of ordinary skill will recognize that other approaches are also possible without departing from the method and apparatus according to the invention. For example, the starting point could assume zero performance for each network component and build a score based on accurate performance.

As previously noted, one feature of the invention is the generation of a normalized composite score for the network as a whole. This provides the network administrator a single overall view of the health of the network at any point in time. One value to such single measures is found in graphing them. Graphing the scores of the network functional component categories and the network overall score for a defined time period, for example, 30 days, can reveal significant information about network performance trends.

Another advantage of a method or apparatus according to the invention arises from correlating information to arrive at an assessment of network performance. For example, while IP addresses are matched to MAC addresses through one mechanism, a separate mechanism identifies the name of the device and the address. By correlating this information, a system and method according to the invention provide a powerful measure of network performance that is system based and holistic and not merely an uncorrelated group of individual network performance parameters.

Another example of the correlations that can be made according to the method and apparatus of the invention concerns VLANs. Although several switches operate together to implement a VLAN, the master switch is often not specified. If priorities are equal, the default operation assigns the master to the switch with the lowest MAC address. A method and apparatus according to the invention would examine priority and a root bridge to correlate and identify the information needed to properly select the root bridge.

A system according to the invention utilizes a set of internal rules to identify network problems or issues. As previously noted, the method and apparatus according to the invention is not dependent upon any particular set of rules. Any set of rules for defining issues and exceptions to measure the health of the network or network subsystems can be employed within the scope of the invention. As a result, a method and apparatus according to the invention has broad applicability to networks of many different types and applications and can grow through the addition of new rule sets to accommodate emerging networks with heretofore unknown performance parameters.

One example of such a rule concerns VLAN configuration and stability. Manual tracking of VLAN membership, topology and ports becomes impossible as a network grows. There are also problems with auto negotiation of speed and duplex on 10/100 Mbps Ethernet ports. In a large Spanning Tree Protocol domain, a slower CPU of a small switch installed in a VLAN can become the root of the spanning tree and become overloaded, causing timeouts in the root's STP advertisements. A spanning tree topology change occurs as the root changes between the small switch and a more powerful core switch. Connectivity via the VLAN suffers during each topology change. One approach is to define a root bridge within the VLAN. By displaying all the switches that are members of the VLAN along with their priority and MAC addresses, it becomes easier to identify improperly selected root bridges and to set the priority of the core switches so that the problem is unlikely to occur. The number of STP topology changes is tracked and if it occurs too many times, an issue is generated. Similarly, individual switch ports can also be monitored and a separate issue generated when a potential duplex mismatch is detected. Thus, this feature provides both a factor to be applied in establishing a measure of network performance and separately, information to useful for diagnosing the network.

Another example of such a rule concerns the Hot Standby Routing Protocol (HSRP) employed by Cisco to increase network reliability. In this protocol, two or more routers share a separate IP and MAC address that is used as a default gateway by members of a subnet. Failures inte redundant configuration can go undetected until the backup fails. While SNMP traps alert a reporting station to the failure of a device or interface, these element failures must be correlated to with the HSRP configuration in order to be identified. Using a more systems level approach, the HSRP shared address is identified as a separate virtual device and the physical routers that comprise the HSRPO group are sub-components. The HSRP configuration is monitored directly to know when a component of the HSRP group has failed.

In particular, the details of an HSRP virtual device are the routers that comprise the HSRP group, analogous to the CPU, memory, and interface components that comprise routers. A method and apparatus according to the invention uses SNMP to learn the details of HSRP configurations and to show the details within a virtual HSRP device display. Thus, a method an apparatus according to the invention generates an issue whenever an HSRP group is found to contain a single router, since this indicates several possible problems included the failure of a second router, the network administrator's failure to add a a redundant router to support HSRP, or a configuration change that caused HSRP peering to fail.

As noted, however, according to the invention, the individual rules are changeable to accommodate any network and to accommodate technologies that have not yet been developed and deployed. The method and apparatus according to the invention provides the network score, in order to allow the administrator to understand the current health of the network by assigning a score and identifying issues and to understand the performance and health trends of the network in order to spot problems and take action before they become critical.

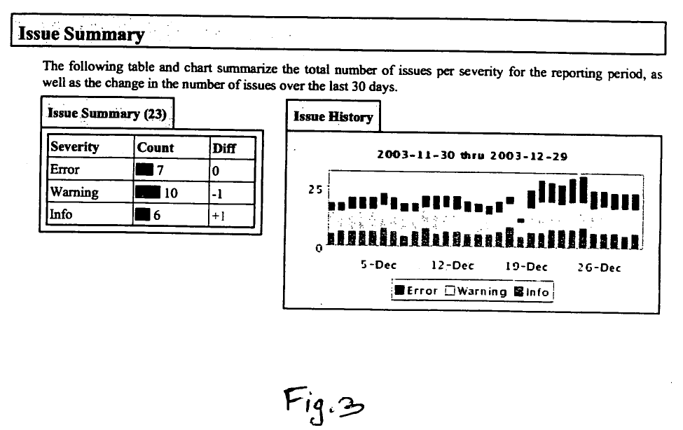

FIGS. 3-10 illustrate other features according to the invention.

FIG. 3 illustrates an issue summary. As shown in FIG. 3, issues are categorized by severity, e.g., error, warning and info. As previously discussed, severity information can be used as weighting criteria in determining the performance metrics of the functional network components. The chart in FIG. 3 gives the number of issues for each of these severity categories for a period of time and the change in the number of issues over the last period of time, for example, 30 days.

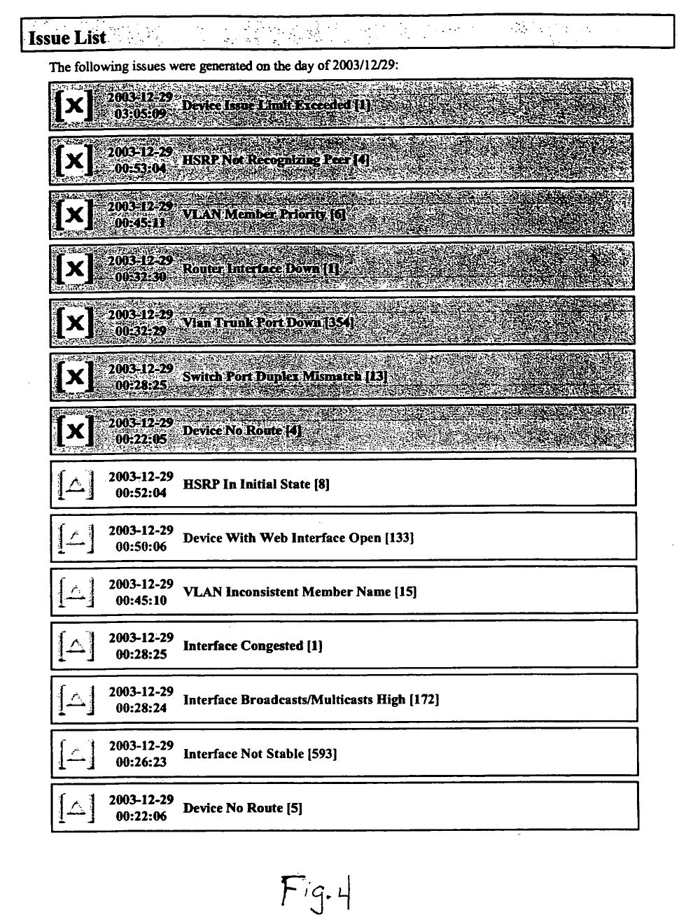

FIG. 4 is an example of an issue list. Issues marked with an X constitute errors, issues with a Δ are warnings, and issues marked with “i” are information issues. The issues are ordered according to severity, using a weighting scheme that reflects technical severity, the number of devices and other factors. The numbers after each issue indicate the number of devices with that particular problem. As previously discussed, this information can be used in the weighting process in determining the performance metrics of the functional network components.

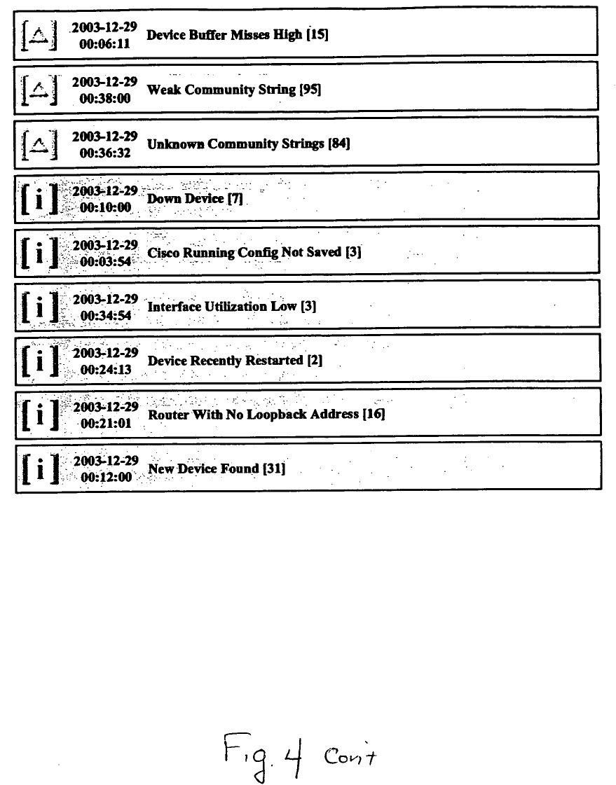

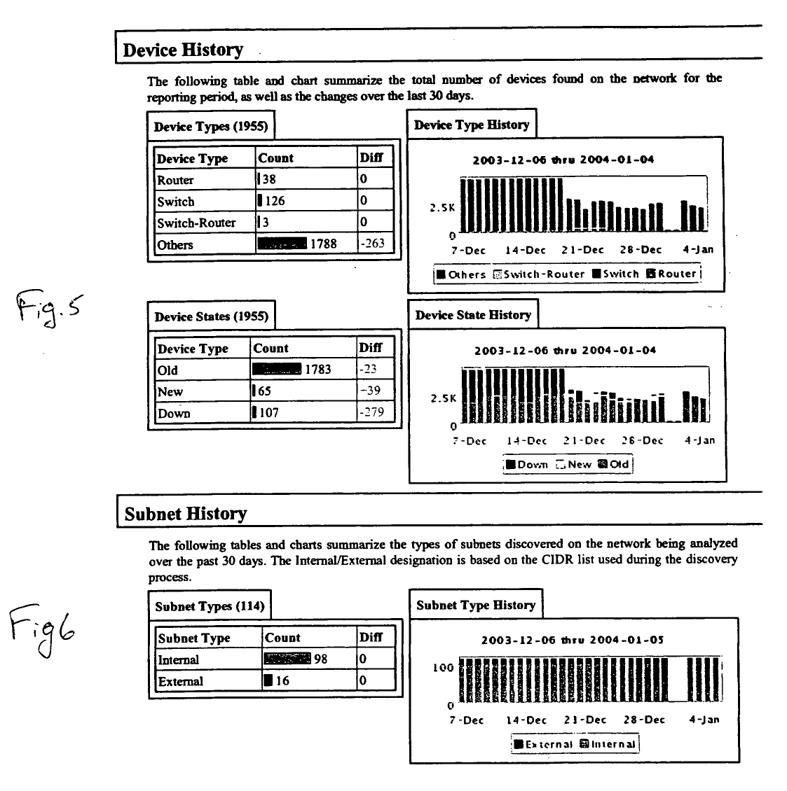

FIG. 5 illustrates a device summary report that identifies the total number of devices found on the network for the reporting period. One chart sorts the devices by type, e.g., router, switch, switch-router and others. It provides a count of the number of devices found and the difference in the number of the devices from the previous reporting period. The second chart identifies the device states as old, new and down or not operational. As shown in FIG. 4, the information can also be provided in chart form.

FIG. 6 shows a subnet summary, which distinguishes, for example, internal from external subnets over the reporting period. This chart also provides a count of the number of such networks and the difference between the current count and the number located in the previous reporting period.

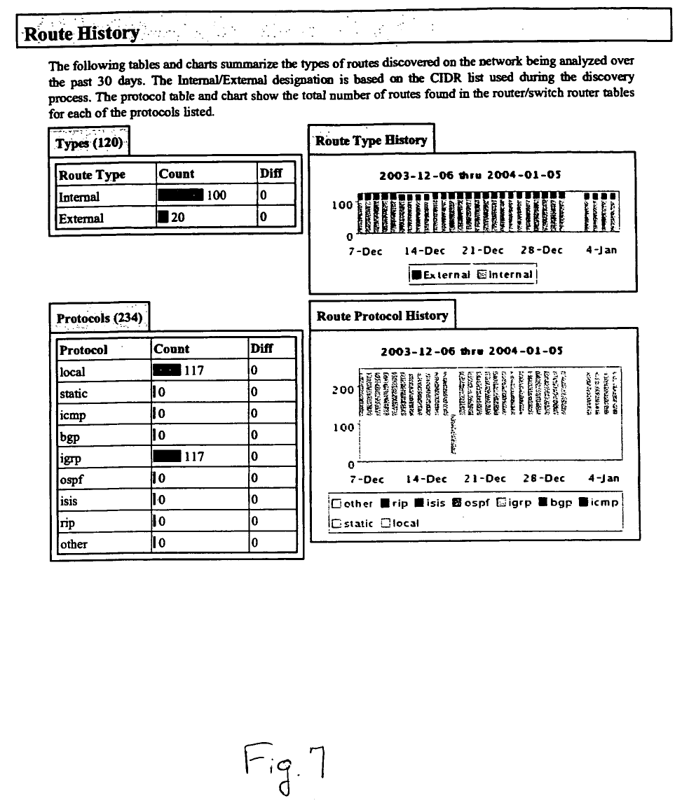

FIG. 7 illustrates a route summary display, which shows routes discovered in the network over the reporting period based on route type, e.g. internal and external, and on protocols.

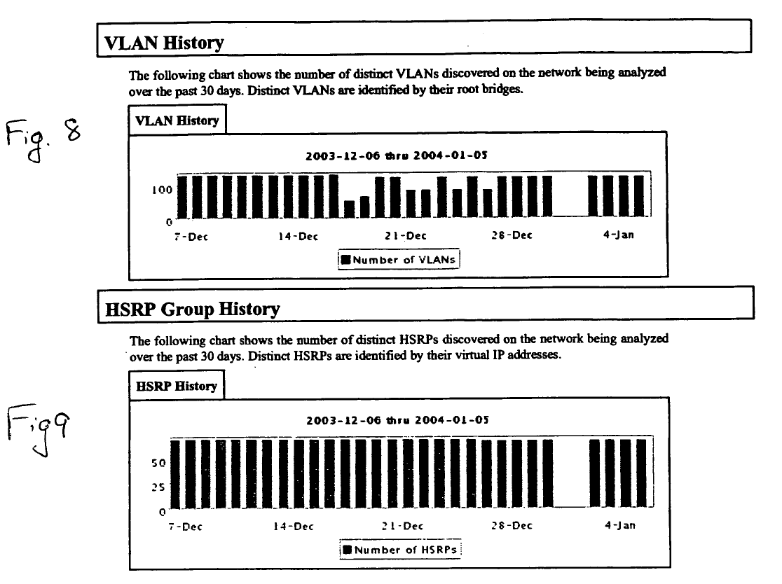

FIG. 8 illustrates a VLAN summary chart, which shows the number of distinct VLANs discovered on the network for the reporting period. A VLAN is identified by its route bridge.

FIG. 9 illustrates a chart showing the number of distinct HSRPs discovered on the network during the reporting period. Distinct HSRPs are identified by their virtual IP addresses.

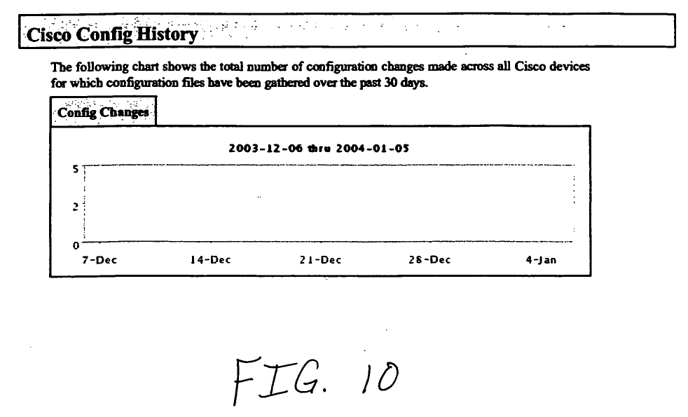

FIG. 10 is a chart showing the number of configuration changes made across all Cisco devices for which configuration files have been gathered over the reporting period.

As discussed above, a method and apparatus according to the invention can be used in real time, but finds application in non-real time situations as well. Indeed, by presenting information about network performance and health gathered over an elapsed time period, a method an apparatus according to the invention allows a network administrator to observe trends and reconfigure network gear to optimize performance. For example, using a method and apparatus according to the invention, a network manager could be alerted to a circumstance where the majority of traffic is being routed through a switch with less processing power than other available switches. In addition, a method an apparatus according to the invention could alert a network administrator to mis-configured switch ports and to optimization possibilities.

An apparatus according to the invention can be configured either as a part of a network processing node or as a network appliance that can be plugged into a network. Such a network appliance would contain processors and memory devices connected in any manner to perform computations discussed herein, as would be know to those of ordinary skill in the art. Software in the apparatus recognizes the device is connected to a network and requests an address, for example, via DHCP. An administrator interface requests certain network information that allows the administrator to specify CIDR blocks of addresses to be managed. The administrator also specifies the SNMP read-only community being used. A system according to the invention then intelligently discovers the network or part of the network to be managed by conducting port scanning and characterizing the devices found, such as Personal Computers, routers, switches, firewalls, and other devices. The system assigns a probability to the accuracy of the device identification.

A system according to the invention can provide reports for any desired time interval, for example, daily or monthly. As noted above, providing by providing reports for a particular reporting period and comparing the results to previous reporting periods, a method and apparatus according to the invention provides a network administrator insight into the performance and health trends of the network.

As previously discussed a method and apparatus according to the invention provides not only a score indicating the relative health of a network, it also provides a list of network issues, as shown in FIG. 4. A method and apparatus according to the invention further provides information summarizing device interfaces and performance graphs that can be used to detect problems, such as steadily decreasing memory, indicating a memory leak. The particular features providing can be tailored to a specific system.

Optionally a method or apparatus according to the invention can also provide information useful for fault management, configuration management, accounting management, performance management and security management.

For example, fault management requires defining a fault, identifying what has changed on the network that characterizes the fault. Other aspects of fault management include storing diagnostic information in a repository, so that the diagnostic information can be accessed when symptoms appear and providing troubleshooting assistance in the form of automatic collection of diagnosis data, problem identification and troubleshooting procedures. These lead to the prediction, detections diagnosis and repair of network faults.

By their nature, network configurations are susceptible to change by any number of actors connected to the network. Thus, it is important to manage the configuration of a network to maintain relative levels of performance. Configuration management activities include collecting configurations, identifying when networks configurations have changes and reporting the changes and their source. A network template can be prepared and configurations checked against the template.

Account management activities include identifying the systems on the networks and the services provided by each. Monitoring the load contributed by each system is an important element of accounting management. Accounting management requires a periodic assessment of such parameters as traffic volume and flow analysis.

Performance management tools go beyond merely measuring the load today, but look into the future to predict when more capacity will be needed and how such capacity needs can be accommodated. Performance management also measures and predicts the effects of configuration changes.

Security management requires identifying servers running on a network identifying and reporting configuration changes, checking infrastructure security, detecting common vulnerabilities, intrusion detection and network access authorization.

Those of ordinary skill will recognize that the individual processes and techniques for fault detection, configuration management, accounting management, performance management and security management are dynamic and change as technology changes. These processes and techniques relate to the present invention to the extent that performance of such functions is necessary to assess the overall health of a network and to provide appropriate data for generating reports. The underlying expert system is susceptible to change and modification as network technology changes.

Those of ordinary skill will also recognize that functional network components may differ between networks and may change over time as technology advances. Thus, it is possible to identify other functional network components or subsystems without departing from the scope of the invention. Similarly, those of ordinary skill will also recognize that different metrics or metric scales may be employed without departing from the scope of the invention.

What is claimed is:

1. A method of representing an operating condition of an information processing network comprising the steps of:
detecting the presence of information processing devices on said information processing network;
gathering data concerning performance parameters of said devices on said network;
correlating said data to arrive at correlations between said data and performance of network functional components; and
synthesizing said data and correlations into a single score indicating the conformance of at least one of said functional network components to a programmed set of network practices.

2. A method as recited in claim 1 comprising the further step of communicating said single score for at least one of said functional network components as a Correct score via a communication device.

3. A method of representing an operating condition of an information processing network comprising the steps of:
detecting the presence of information processing devices on said information processing network;
gathering data concerning performance parameters of said devices on said network;
correlating said data to arrive at correlations between said data and performance of network functional components; and
synthesizing said data and correlations into a single score indicating stability of at least one of said network functional components.

4. A method as recited in claim 3 comprising the step of communicating said score indicating stability of one of said network functional components through a communications device.

5. A method as recited in claim 1 comprising synthesizing said data and correlations into a single score indicating the conformance of said network to a programmed set of network practices.

6. A method as recited in claim 3 comprising synthesizing said data and correlations into a single score indicating a stability value of said network.

7. A method as recited in claim 1 further comprising synthesizing said data and correlations into a single score indicating stability of at least one of said network functional components.

8. A method as recited in claim 7 comprising combining said single network score for at least one of said functional network components as a Correct score and said single score indicating stability of at least one of said network functional component as a Stability score into a single network health score.

9. A method as recited in claim 8, comprising communicating said single network health score through a communications device.

10. A method as recited in claim 9, wherein said communications device is a display.

11. A method as recited in claim 1, comprising synthesizing said data and said correlations in a processing node of said network.

12. A method as recited in claim 1, comprising synthesizing said data and said correlations in a non-network device connected to said network, said device comprising memory and computing resources to perform said synthesizing.

13. A method as recited in claim 1, comprising weighing said data as a function of severity of impact to network performance to arrive at said single score.

14. A method as recited in claim 3, comprising weighing said data as a function of severity of impact to network performance to arrive at said single score.

15. A method as recited in claim 8, comprising averaging said Correct score and said Stability score for each said network functional component to arrive at said single network health score.

16. An apparatus for representing an operating condition of an information processing network comprising:
means for detecting the presence of information processing devices on said information processing network;
means for gathering data concerning performance parameters of said devices on said network;
means for correlating said data to arrive at correlations between said data and performance of network functional components; and
means for synthesizing said data and correlations into a single Correct score indicating the conformance of at least one of said functional network components to a programmed set of network practices.

17. An apparatus as recited in claim 16, said apparatus comprising a processing node on said network.

18. An apparatus as recited in claim 16, said apparatus being separate from said network and being connectable to said network.

19. An apparatus as recited in claim 16, comprising means for communicating said single Correct score.

20. An apparatus as recited in claim 19, said means for communicating comprising at least one of a display and an audio device.

21. An apparatus as recited in claim 16, comprising means for synthesizing said data and correlations into a single Stability score indicating stability of at least one of said network functional components.

22. An apparatus as recited in claim 21, comprising means for combining said single Correct score and said single Stability score into a single network health score.

23. An apparatus for representing an operating condition of an information processing network comprising a processor and a memory, said processor accessing stored program indicia directing said processor to:
detect the presence of information processing devices on said information processing network;
gather data concerning performance parameters of said devices on said network;
correlate said data to arrive at correlations between said data and performance of network functional components; and
synthesize said data and correlations into a single score Correct indicating the conformance of at least one of said functional network components to a programmed set of network practices.

24. An apparatus as recited in claim 23, comprising a processing node on said network.

25. An apparatus as recited in claim 23, said apparatus being separate from said network and connectable to said network.

26. An apparatus as recited in claim 23, said processor accessing stored program indicia to synthesize said data and correlations into a single Stability score indicating stability of at least one of said network functional components.

27. An apparatus as recited in claim 26, said processor accessing stored program indicia to combine said Correct score and said Stability score into a single network health score.

28. An apparatus as recited in claim 26, said processor accessing said stored indicia to weigh said data as a function of severity of impact on network performance when determining at least one of said Correct score and said Stability score.

29. An apparatus as recited in claim 28, said processor accessing stored program indicia to average said Correct score and said Stability score to arrive at said single network health score.
